(19) United States
(12) Patent Application Publication
(10) Pub. No.: US 2025/0095141 A1
(43) Pub. Date: Mar. 20, 2025

(54) METHOD AND SYSTEM OF DETECTING AND CLASSIFYING AN OBJECT IN REAL-TIME MEDICAL IMAGING

(71) Applicant: L&T TECHNOLOGY SERVICES LIMITED, Chennai (IN)

(72) Inventors: SREERAG HAREENDRANATH, Kannur (IN); AKSHAYA BABU, Kochi (IN); ANUSREE KAREEPARAMBATH, Kozhikode (IN)

(21) Appl. No.: 18/387,483

(22) Filed: Nov. 7, 2023

(30) Foreign Application Priority Data
Sep. 14, 2023 (IN) 202341062089

(51) Int. Cl. G06T 7/00; G06T 5/00; G06V 10/25; G06V 10/54; G06V 10/56; G06V 10/764

(52) U.S. Cl. CPC G06T 7/0012; G06T 5/70; G06T 5/92; G06V 10/25; G06V 10/54; G06V 10/56; G06V 10/764; G06T 2207/30096; G06V 2201/07

(57) ABSTRACT

A method for detecting and classifying an object is disclosed. The method includes receiving imaging data captured by imaging device. Further, the method includes generating a pre-processed image frame by correcting one or more pixels corresponding to reflections in corresponding image frame using autoencoder based DL model. Further the corrected image is split into R channel image, G channel image, and B channel image. Further, texture enhancement of G channel image and denoising the B channel image using wiener filter is performed to generate a color enhanced image frame. Further, regions of interest are determined corresponding to at least one object in the pre-processed image frame using SSD model. Further, the at least one object is classified as one of: cancerous type, pre-cancerous type or non-cancerous type using a CNN model.

### TECHNICAL FIELD

This disclosure relates generally to image processing, more particularly to a method and system of detecting and classifying an object in real-time using Deep Learning (DL) techniques.

### BACKGROUND

Medical imaging plays a crucial role in the diagnosis and treatment of various medical conditions. Medical imaging methodologies, such as endoscopy, colonoscopy, X-rays, CT scans, MRI, and ultrasound, provide valuable information about abnormal tissue growth, internal structures, and abnormalities in the human body. However, the accurate and timely identification and classification of specific objects, such as polyps, tumors, lesions, organs, or anatomical landmarks, in medical images are essential for accurate diagnosis and appropriate medical interventions. However, in real-world scenarios, medical images are often subject to various distortions and noise, therefore there is a requirement of correcting various distortions in order to effectively use the images for their intended use.

Conventional methods for object detection and classification in medical imaging typically rely on manual inspection by radiologists or medical professionals, which can be time-consuming and subject to human error. Furthermore, some conditions may require real-time analysis during medical procedures, demanding immediate identification and classification of critical objects. Additionally, these traditional approaches lack the adaptability and learning capability necessary to handle diverse and challenging scenarios effectively.

Thus, there is a need to provide a method and a system of detecting and classifying an object in real-time medical imaging, which may process medical images for an accurate detection, and classification of abnormalities.

### SUMMARY OF THE INVENTION

In an embodiment, a method of detecting and classifying an object in real-time medical imaging is disclosed. The method may include receiving a real-time imaging data captured by an imaging device. In some embodiments, the imaging data may include a set of image frames. For each of the set of image frames, the method may include generating a pre-processed image frame. The generation of pre-processed image frame may include correcting one or more pixels corresponding to one or more reflections in a corresponding image frame using an autoencoder based deep learning (DL) model. Further, the generation of pre-processed image frame may include splitting the corrected image frame into an R channel image, a G channel image, and a B channel image. The generation of pre-processed image frame may further include performing texture enhancement of the G channel image. Further, the generation of pre-processed image frame may include denoising the B channel image using a Wiener filter. The generation of pre-processed image frame may include generating a color enhanced image frame from the R channel image, the texture enhanced G channel image and the denoised B channel image. Further, the method may include determining at least one region of interest corresponding to at least one object in the pre-processed image frame using a Single Shot Detection (SSD) model. In an embodiment, the SSD model is pre-trained to detect the at least one object by extracting one or more features from the pre-processed image frame corresponding to the at least one object. The method may further include classifying the at least one object as one of: a cancerous type, a pre-cancerous type or a non-cancerous type using a Convolution Neural Network (CNN) model.

In another embodiment, a system for detecting and classifying an object in real-time medical imaging is disclosed. The system may include a processor and a memory communicatively coupled to the processor. The memory may store processor-executable instructions, which, on execution, may cause the processor to receive real-time imaging data captured by an imaging device. In some embodiments, the imaging data include a set of image frames. For each of the set of image frames, the processor-executable instructions, on execution, further cause the processor to generate a pre-processed image frame. In some embodiments, the generation of the pre-processed image frame may include the processor to correct one or more pixels corresponding to one or more reflections in a corresponding image frame using an autoencoder based deep learning (DL) model. Further, the generation of the pre-processed image frame may include the processor to split the corrected image frame into an R channel image, a G channel image, and a B channel image. The processor may further perform texture enhancement of the G channel image frame and denoise the B channel image using a Wiener filter. Further, the processor may generate a color enhanced image frame from the R channel image, the texture enhanced G channel image and the denoised B channel image. The processor-executable instructions may cause the processor to determine at least one region of interest corresponding to at least one object in the pre-processed image frame using a Single Shot Detection (SSD) model. In an embodiment, the SSD model is pre-trained to detect the at least one object by extracting one or more features from the pre-processed image frame corresponding to the at least one object. The processor-executable instructions may further cause the processor to classify the at least one object as one of: a cancerous type, a pre-cancerous type or a non-cancerous type using a Convolution Neural Network (CNN) model.

Various objects, features, aspects, and advantages of the inventive subject matter will become more apparent from the following detailed description of preferred embodiments, along with the accompanying drawing figures in which like numerals represent like components.

### BRIEF DESCRIPTION OF THE DRAWINGS

The accompanying drawings, which are incorporated in and constitute a part of this disclosure, illustrate exemplary embodiments and, together with the description, serve to explain the disclosed principles.

FIG. 1 illustrates a block diagram of a system detecting and classifying an object in real-time medical imaging, in accordance with some embodiments of the current disclosure.

FIG. 2 illustrates a functional block diagram of the processing unit, in accordance with an embodiment of the current disclosure.

FIG. 3 illustrates a flowchart of a method of generating a pre-processed image for detecting and classifying an object in real-time medical imaging, in accordance with an embodiment of the current disclosure.

FIG. 4 illustrates exemplary input image and output images generated by the processing unit, in accordance with an embodiment of the current disclosure.

FIG. 5 illustrates a Single Shot Detection (SSD) model for detecting and classifying an object in real-time medical imaging, in accordance with an embodiment of the current disclosure.

FIG. 6 illustrates a flowchart of a method for detecting and classifying an object in real-time medical imaging, in accordance with an embodiment of the current disclosure.

### DETAILED DESCRIPTION OF THE DRAWINGS

Exemplary embodiments are described with reference to the accompanying drawings. Wherever convenient, the same reference numbers are used throughout the drawings to refer to the same or like parts. While examples and features of disclosed principles are described herein, modifications, adaptations, and other implementations are possible without departing from the scope of the disclosed embodiments. It is intended that the following detailed description be considered as exemplary only, with the true scope being indicated by the following claims. Additional illustrative embodiments are listed.

In the figures, similar components and/or features may have the same reference label. Further, various components of the same type may be distinguished by following the reference label with a second label that distinguishes among the similar components. If only the first reference label is used in the specification, the description is applicable to any one of the similar components having the same first reference label irrespective of the second reference label.

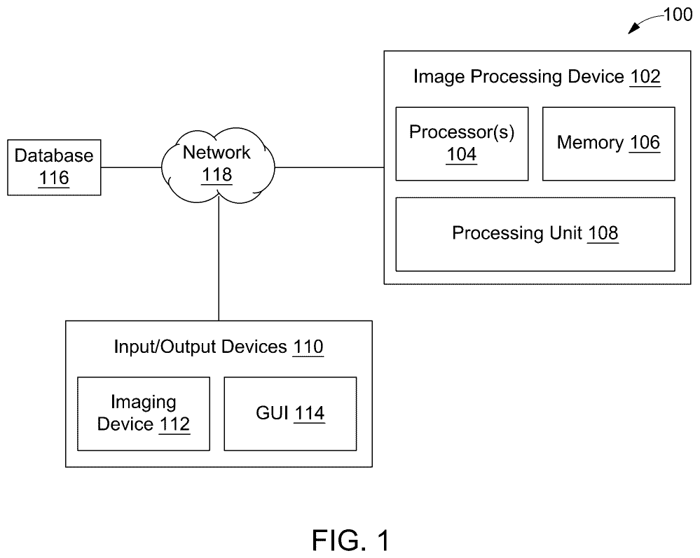

Referring to FIG. 1, a block diagram of a system 100 for detecting and classifying an object in real-time medical imaging is illustrated, in accordance with some embodiment of the current disclosure. The system 100 may include image processing device 102, an input/output device 110, a database 116 communicably coupled to each other through a wired or a wireless communication network 118. The image processing device 102 may include a processor(s) 104, a memory 106 and a processing unit 108. In an embodiment, examples of processor(s) 104 may include, but are not limited to, an Intel® Itanium® or Itanium 2 processor(s), or AMD® Opteron® or Athlon MP® processor(s), Motorola® lines of processors, Nvidia®, FortiSOC™ system-on-a-chip processors or other future processors. The memory 106 may store instructions that, when executed by the processor 104, cause the processor 104 to detect and classify the objects in real-time medical imaging. The memory 106 may be a non-volatile memory or a volatile memory. Examples of non-volatile memory may include but are not limited to a flash memory, a Read Only Memory (ROM), a Programmable ROM (PROM), Erasable PROM (EPROM), and Electrically EPROM (EEPROM) memory.

Examples of volatile memory may include but are not limited to Dynamic Random Access Memory (DRAM), and Static Random-Access memory (SRAM).

In an embodiment, the input/output device(s) 110 may include an imaging device 112 and a Graphical User Interface (GUI) 114. The imaging device 112 may capture images from a medical device or any other device. In some embodiments, the imaging device 112 may receive real-time imaging data and may transmit the real-time imaging data to the image processing device 102 via the network 118. In an embodiment, imaging device 112 may be, but not limited to, a handled camera, a mobile phone, a medical thermal cameras, a surveillance camera, a tablet, a PC, a minimally invasive surgical device, or any other image capturing device. In an embodiment, the imaging device 112 may include one or more imaging sensors which may capture images as continuous frames in order to capture real-time imaging data. In an embodiment, the imaging device 112 may be provided on a medical device for performing one or more invasive medical procedures, such as, but not limited to, endoscopy, colonoscopy, etc. The GUI 114 may render the output generated by the image processing device 102. The GUI 114 may be, but not limited to a display, a PC, any handheld device, or any other device with a digital screen. Further, the input/output device(s) 110 may be connected to the database 116 and the image processing device 102 via the network 118.

In an embodiment, the database 116 may be enabled in a cloud or physical database comprising data such as configuration information of the image processing device 102, the training datasets of the DL models and a Single Shot Detection (SSD) model. In an embodiment, the database 116 may store data input or generated by the image processing device 102.

In an embodiment, the communication network 118 may be a wired or a wireless network or a combination thereof. The network 118 can be implemented as one of the different types of networks, such as but not limited to, ethernet IP network, intranet, local area network (LAN), wide area network (WAN), the internet, Wi-Fi, LTE network, CDMA network, 5G and the like. Further, network 118 can either be a dedicated network or a shared network. The shared network represents an association of the different types of networks that use a variety of protocols, for example, Hypertext Transfer Protocol (HTTP), Transmission Control Protocol/Internet Protocol (TCP/IP), Wireless Application Protocol (WAP), and the like, to communicate with one another. Further, network 118 may include a variety of network devices, including routers, bridges, servers, image processing devices, storage devices, and the like.

In an embodiment, the image processing device 102 may be an image processing systems, including but not limited to, a smart phone, a laptop computer, a desktop computer, a notebook, a workstation, a portable computer, a personal digital assistant, a handheld, or a mobile device. In an embodiment, the processing unit 108 may enable detecting and classifying an object in real-time medical imaging using the DL techniques and the SSD model.

In an embodiment, the real-time imaging data captured by the imaging device 112 may include a set of image frames.

Further, for each of the set of image frames the image processing device 102 may generate a pre-processed image frame. The generation of pre-processed image frame may include the image processing device 102 to correct one or more pixels corresponding to one or more reflections in a corresponding image frame using an autoencoder based deep learning (DL) model. The autoencoder based DL model may be trained to correct one or more pixels corresponding to the one or more reflections based on the corresponding input image frame. In some embodiments, one or more reflections may include, but not limited to, specular reflections. In an embodiment, while performing a medical procedure such as, but not limited to, colonoscopy or endoscopy, a surgical device such as a colonoscope or an endoscope comprising the imaging device 112 may be inserted through one or more cavities of a patient. The passage of the such cavities may be restricted due to presence of various matters such as, but not limited to, fecal matter, etc. Therefore, the view of the imaging device 112 may be restricted. Accordingly, the surgical device may include a water jet which may be used to wash a region in order to remove restriction in the passage or clear the view of the imaging device 112. Due to the presence of water on surface of the regions, there may be specular reflections present in the images being captured by the imaging device 112. More details related to the methodology of correcting one or more pixels corresponding to one or more reflections are discussed in the related application titled “SPECULAR CORRECTION OF IMAGES USING AUTOENCODER NEURAL NETWORK MODEL” filed subsequently with the current application and the disclosure of which is incorporated herein in its entirety based on reference.

In some embodiments, upon correction of the one or more reflections such as specular reflections in the image frame, the image processing device 102 may generate a contrast enhances image frame by enhancing a contrast level of the corresponding image frame using a gamma correction technique based on a first predefined gamma correction parameter. In an embodiment, the gamma correction parameter may be predefined as 1.85. Further, the generation of pre-processed image frame may include the image processing device 102 to split the contrast enhanced image frame into an R channel image, a G channel image, and a B channel image. In some embodiments, the image processing device 102 may perform the texture enhancement of the G channel image frame. Further, the image processing device 102 may also denoise the B channel image frame using a Wiener filter. The image processing device 102 may further generate a color enhanced image frame from the R channel image frame, the texture enhanced G channel image and the denoised B channel image.

In some embodiments, the generation of the color enhanced image frame may include normalizing the R channel image, the texture enhanced G channel image, and the denoised B channel image based on a predefined normalization threshold range. The generation of the color enhanced image frame may further cause the image processing device 102 to determine a modified RGB image frame based on a predefined modification factor and performing a gamma correction based on a second predefined gamma correction parameter. In an embodiment, the determination of the modified RGB image frame may cause the image processing device 102 to generate a normalized RGB image by combining the normalized R channel image, the texture enhanced G channel image, and the denoised B channel image. Further, the image processing device 102 may segregate each of a plurality of pixels of the normalized RGB image into one of a first cluster or a second cluster based on a pre-defined clustering threshold. The image processing device 102 may further generate an enhanced image frame by scaling each of the plurality of pixels of the first cluster and the second cluster based on a first scaling factor and a second first scaling factor respectively.

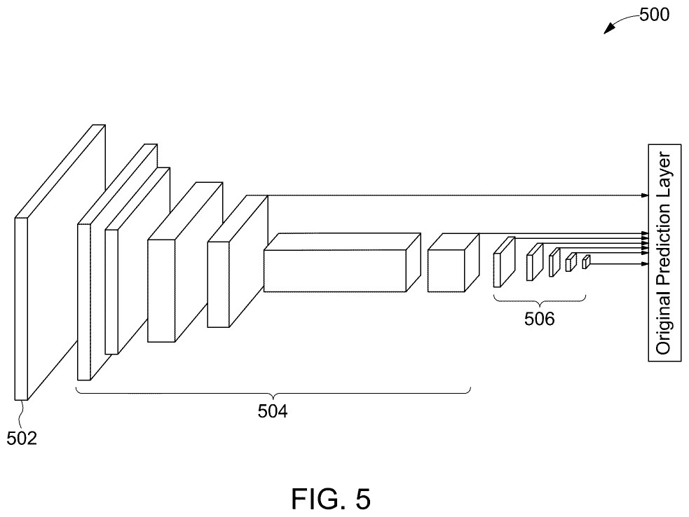

In an embodiment, the image processing device 102 may determine at least one region of interest corresponding to at least one object in the pre-processed image frame using the Single Shot Detection (SSD) model. The SSD model may be pre-trained to detect the at least one object by extracting one or more features from the pre-processed image frame corresponding to the at least one object. In some embodiments, the SSD model may include a backbone model and an SSD head. The backbone model may be a pre-trained image detection network configured to extract the one or more features, and the SSD head may include a plurality of convolutional layers stacked on top of the backbone model as explained in detail in FIG. 5 below.

Further, the image processing device 102 of the system 100 may classify the at least one object as one of: a cancerous type, a pre-cancerous type or a non-cancerous type using a neural network model such as, but not limited to, Convolution Neural Network (CNN) model. The CNN model may be pretrained to determine a class of the at least one object from one of the cancerous type, the pre-cancerous type or the non-cancerous type based on determination of one or more object classification features. In some embodiments, the image processing device 102 may display the real-time imaging data on a display screen with a bounding box corresponding to the at least one object in each of the corresponding pre-processed image frames. Further, the image processing device 102 may generate a report along with the bounding box. The report may include the classification of the at least one object and one or more recommendations determined based on the classification of the at least one object.

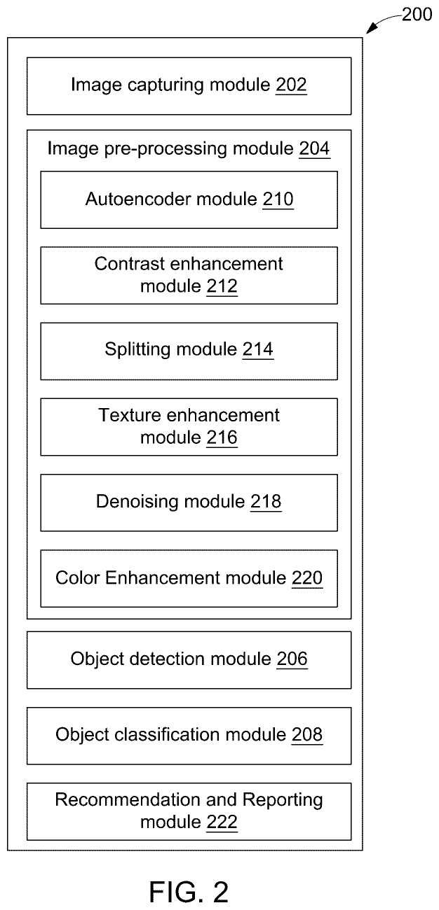

Referring now to FIG. 2, a functional block diagram of the processing unit 108 is illustrated, in accordance with an embodiment of current disclosure. FIG. 2 is explained in conjunction with the FIG. 1. In some embodiments, the processing unit 108 may include an image capturing module 202, an image pre-processing module 204, an object detection module 206, and an object classification module 208. Further, the image pre-processing module 204 may include an autoencoder module 210, a contrast enhancement module 212, a splitting module 214, a texture enhancement module 216, a denoising module 218, a color enhancement module 220, and recommendation and reporting module 222.

In some embodiments, the image capturing module 202 of the processing unit 108 may capture real-time imaging data including the set of image frames using the imaging device 112 during an invasive or minimally invasive medical procedure. The image capturing module 202 may transmit each of the set of image frames for further processing to the image pre-processing module 204.

Further, the image pre-processing module 204 of the processing unit 108 may pre-process each of the set of image frames transmitted from the image capturing module 202. The image pre-processing module 204 may receive the set of image frames as they are captured in real time by the image capturing module 202 of the processing unit 108. The image pre-processing module 204 may include an autoencoder module 204 that may utilize an autoencoder based deep learning model to correct one or more reflections that may be present in each of the set of image frames. In some embodiments, the autoencoder module 210 of the image pre-processing module 204 may implement an unsupervised neural network to determine the one or more reflections such as, but not limited to, specular reflections in the set of image frames. In an embodiment, the autoencoder module 210 may use an unsupervised autoencoder based neural network model that may include a plurality of encoding layers and a plurality of decoding layers. In an embodiment, the plurality of encoding layers and the plurality of decoding layers may be convolutional layers.

In some embodiments, the image pre-processing module 204 of the processing unit 108 may include the contrast enhancement module 212 that may enhance the contrast of each of the set of image frames. The contrast enhancement module 204 may implement a gamma correction technique to enhance the contrast of each of the set of image frames. The gamma correction technique may be a non-linear operation used to encode and decode luminance values of each pixel of each set of image frames. In an embodiment, the gamma correction technique may use a first predefined gamma correction parameter that may be selected as, but not limited to, 1.85. In some embodiments, the image pre-processing module 204 of the processing unit 108 may include the splitting module 214 that may split each of the set of image frames into an R channel image, a G channel image, and a B channel image. In an embodiment, the R channel image, the G channel image and the B channel image may be utilized to determine texture information, noise information and edge information from the image frames. In an embodiment, the B channel image may be used to determine the noise and distortion information in the image frames. The G channel image may be further processed by the texture enhancement module 216 to enhance the texture of the G channel image. In some embodiments, the texture enhancement module 216 of the image pre-processing module 204 may enhance the texture of the G channel image. The texture enhancement module 216 may implement one or more texture and edge enhancing techniques such as, but not limited to, an unsharp masking technique.

Further, the B channel image may be further processed by the denoising module 218 for removing noise from the B channel image.

In an embodiment, the denoising module 218 of the image pre-processing module 204 may denoise the noise and distortions in the B channel image by using a Wiener filter. It should be noted that the texture enhancement module 216 and the denoising module 218 may simultaneously process the G channel image and the B channel image respectively.

In some embodiments, the color enhancement module 220 of the processing unit 108 may receive the R channel image from the splitting module 214, the texture enhanced G channel image from the texture enhancement module 216 and the denoised B channel image from the denoising module 218. The color enhancement module 220 may normalize the R channel image, the texture enhanced G channel image and the denoised B channel image. In an embodiment, the normalization may be performed based on a predefined normalization threshold range. Upon normalization each of a plurality of pixels of the normalized the R channel image, the texture enhanced G channel image, and the denoised B channel image may be segregated into one of a first cluster or a second cluster based on a pre-defined clustering threshold. In an embodiment, the pre-defined clustering threshold may be selected as, but not limited to, 0.0405. Further, the color enhancement module 220 may generate a pre-processed image by generating an enhanced image frame by scaling each of the plurality of pixels of the first cluster and the second cluster based on a first scaling factor and a second first scaling factor respectively. In an embodiment, pixels may be clustered in the first cluster in case the pixel value is less than the pre-defined clustering threshold. Further, pixels may be clustered in the second cluster in case the pixel value is greater than the pre-defined clustering threshold. In an embodiment, pixel values of each of the pixels in the first cluster may be scaled based on a first scaling factor. In an embodiment, the first scaling factor may be added to the pixel values of each of the pixels in the first cluster. In an embodiment, the first scaling factor may be determined based on experiments. In an embodiment, the first scaling factor may be equal to but not limited to, 0.055)/1.055. The enhanced image may be determined based on summation or combination of each of the plurality of pixels of the first cluster and the second cluster.

In an embodiment, pixel values of each of the pixels in the second cluster may be scaled based on a second scaling factor. In an embodiment, the pixel values of each of the pixels in the second cluster may be divided by the second scaling factor. In an embodiment, the second scaling factor may be determined based on experiments. In an embodiment, the second scaling factor may be equal to but not limited to, 12.92. In an embodiment, the first scaling factor and the second scaling factor may be determined based on experimental results.

The enhanced RGB image frame is scaled based on a third scaling factor to generate a pixel modified RGB image frame. In an embodiment, the pixel modified RGB image frame may be gamma corrected based on a second predefined gamma parameter.

In some embodiments, the object detection module 206 of the processing unit 108 may receive the pre-processed input image from the image pre-processing module 204. The object detection module 206 may implement a deep learning (DL) model to detect a plurality of objects in the pre-processed image. The deep learning model may be a Single Shot Detection (SSD) model which may detect and classify objects in a single forward pass. In some embodiments, the object detection module 206 may predict category scores and box offsets for fixed default bounding boxes using filters that may be applied to feature maps of the image frames. Further, to achieve high accuracy, different scale predictions are produced from the feature maps which may then be separated by aspect ratio. As a result, even on images with low resolution, high accuracy may be achieved. In an embodiment, the object detection module 206 may detect one or more regions of interest that may correspond to polyps in the image frames.

In some embodiments, the object classification module 208 of the processing unit 108 may classify the detected objects by the object detection module 206 into a plurality of categories. Further, the object classification module 208 may generate a report which may include the detected object and the corresponding category. The object classification module 208 may use one of a plurality of classification models to classify the objects. Examples of classification models may include, but not limited to, a CNN, an efficientNetB0, a VGG16, a Rasnet50 using ImageNet weights, etc. In an embodiment, the object classification module 208 may classify one or more regions of interest corresponding to polyps into a plurality of categories using the classification model such as, but not limited to, VGG16 classification model. In an embodiment, the one or more regions of interest corresponding to polyps may be categorized as a non-cancerous polyp, a pre-cancerous polyp, and a cancerous polyp.

In an embodiment, the GUI 114 may display the pre-processed image frames of the imaging data. Further, based on the determination of the one or more regions of interest in the each of the image frames of the real time imaging data being captured by the imaging device 112, one or more bounding boxes may be displayed by the GUI 114 indicating detection of one or more polyps in each of the pre-processed image frames.

The recommendation and reporting module 222 may generate a report depicting the determined category of the one or more polyps by the object classification module 208. Further, the report may include information about the one or more polyps detected by the object detection module 206 such as, but not limited to, size of the polyp, category of the polyp, etc. Further, based on the classification determined by the object classification module 208 the recommendation and reporting module 222 may also generate one or more recommendations for each of the detected polyp and its corresponding category. In an embodiment, the one or more recommendations may include, but not be limited to, urgency of doctor intervention required, any further diagnosis required, a type of medical procedure suggested, risk level, etc. In an embodiment, the report and the one or more recommendations may be displayed by the GUI 114 for each of the polyps detected in the image frames of the imaging data.

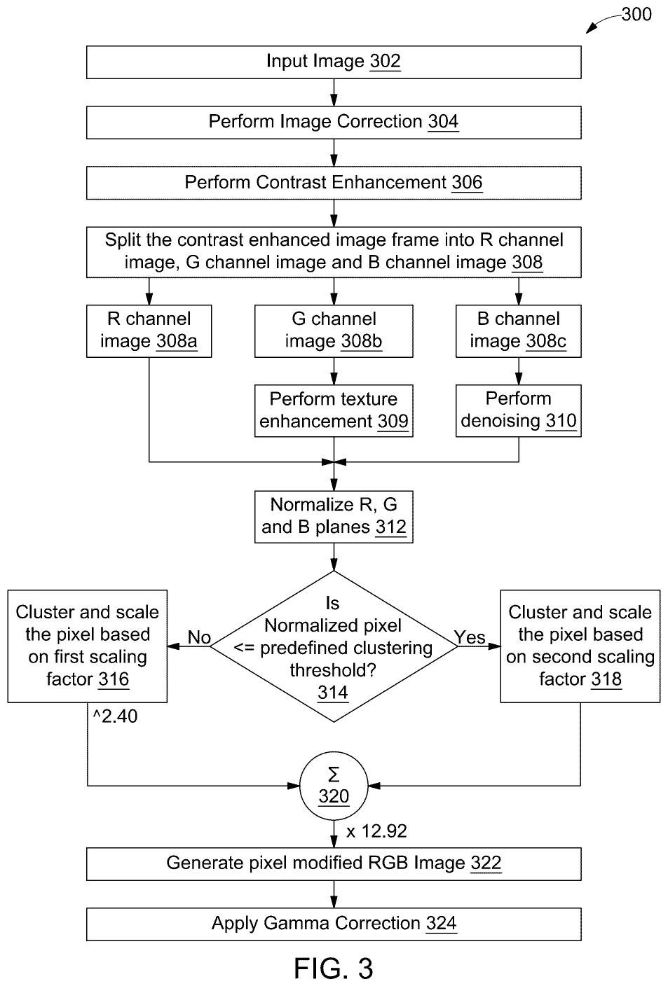

Referring now to FIG. 3, a method of generating a pre-processed image for detecting and classifying an object in real-time medical imaging is disclosed via a flowchart 300, in accordance with an embodiment of the current disclosure. FIG. 3 is explained in conjunction with FIGS. 1 and 2. Each step of the flowchart 300 may be executed by, but not limited to, the image pre-processing module 204 of the processing unit 108.

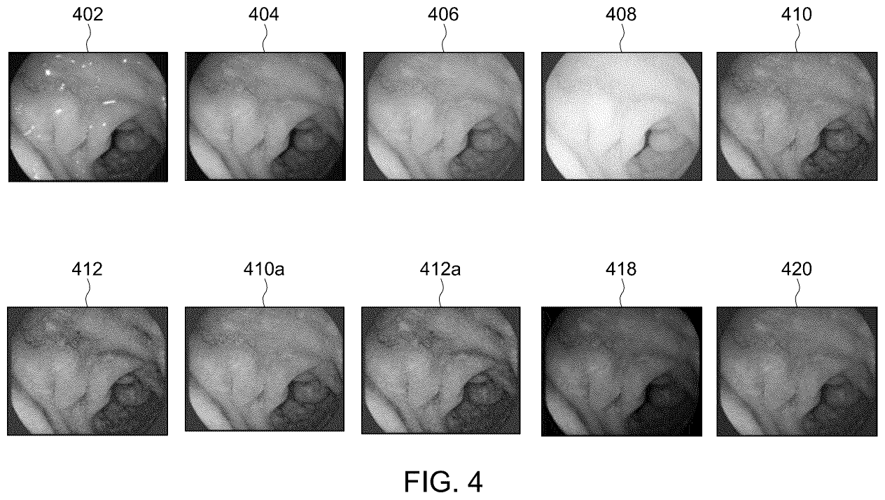

A step 302, the image pre-processing module 204 may receive an image frame from the set of image frames of the real-time imaging data captured by the imaging device 112. In an embodiment, the imaging data may be captured while performing a minimally invasive medical procedure such as endoscopy, colonoscopy, etc. Referring now to FIG. 4 that illustrates exemplary input image and output images generated by the processing unit 102, in accordance with an embodiment of the current disclosure. Image 402 depicts one image frame from the set of image frames being captured by the imaging device 112. The image 402 depicts various specular reflections being captured. Due to presence of specular reflections, detection of polyps may be erroneous as such polyps may be obscured due to the specular reflections.

Accordingly, at step 304, the image pre-processing module 204 may perform image correction to correct the image frame to remove the specular reflections. In an embodiment, the image pre-processing module 204 may use the autoencoder based deep learning (DL) model to correct the specular reflections as described in FIG. 1 and FIG. 2. FIG. 4, depicts the corrected image frame 404 of the input image frame 402. The corrected image 404 may be generated by the pre-processing module 204 by correcting the specular reflections in the input image frame 402.

Further, the image pre-processing module 204 at step 306, may perform contrast enhancement of the corrected image frame 404. In an embodiment, the enhancement of the contrast or luminance of the corrected image frame may enable identification of a plurality of image features. The image pre-processing module 204 may perform contrast enhancement by implementing a gamma correction technique based on a gamma correction parameter. It should be noted that the gamma correction parameter may be selected manually as per intended use. In some embodiments, the image pre-processing module 204 may preserve a mean brightness for invasive medical imaging data. FIG. 4 depicts a contrast enhanced image frame 406 generated from the corrected image frame 404.

Further, the splitting module 214 at step 308, may split the contrast enhanced image frame into an R channel image at step 308a, a G channel image at step 308b, and a B channel image at step 308c. FIG. 4 depicts the corresponding R channel image 408, a G channel image 410 and B channel image 412 generated from the contrast enhance image frame 406.

Further, at step 309, the image pre-processing module 204 may perform texture enhancement on the G channel image 410 determined at step 308b to enhance the texture of the image frame 410. The image pre-processing module 204 may implement the unsharp masking technique to enhance the edges and texture of the G channel image 410 to generate a texture enhanced G channel image 410a as depicted in FIG. 4.

At step 310, the image pre-processing module 204 may perform the denoising on the B channel image generated at step 308c to remove the noise and distortion from the imaging data. The denoising module 218 of the image pre-processing module 204 may denoise the B channel image 412 in a way that the noise level is reduced without affecting the edge quality. In some embodiments, the denoising module 218 may implement a wiener filter to perform the denoising of the B channel image 412 to generate a denoised B channel image 412a as depicted in FIG. 4. It should be noted that the image pre-processing module 204 may perform the steps 308-310 simultaneously and independent of each other.

Further, at step 312, upon performing the texture enhancement of the G channel image at step 309 and the denoising of the B channel image at step 310, the image pre-processing module 204 may normalize the R channel image, the texture enhanced G channel image, and the denoised B channel image at step 312. The normalization at step 312 may be performed based on a pre-defined normalization threshold range. In some embodiments, the normalization may change the range of pixel intensity values within the normalization range. The normalization of the plurality of channel images may bring the image, or other type of signal, into a range that may be more familiar or normal to the senses. By a way of an example, if the intensity range of the image is 50 to 180 and the desired range is 0 to 255 the process entails subtracting 50 from each of pixel intensity, making the range 0 to 130. Then each pixel intensity is multiplied by 255/130, making the range 0 to 255. Further, each of the normalized pixel of the normalized the R channel image, the texture enhanced G channel image, and the denoised B channel image may be combined to determine a normalized RGB image.

At step 314, each of the pixel value of the normalized RGB image may be compared with a predefined clustering threshold. By way of an example, each the normalized pixel of the RGB image is compared with the predefined clustering threshold value of 0.0405 and segregated into two clusters.

Further, if the pixel value of the normalized RGB image is less than the predefined threshold, at step 314, the pixels may be clustered in first cluster at step 316. The pixel values in the first cluster may be scaled based on the first scaling parameter. In an embodiment, at step 316, the first scaling factor is added to each of the normalized pixel value in the first cluster based on equation (1) given below:

$$\frac{( Normalized pixel + 0.055 )}{1.055} \qquad ( 1 )$$

In an embodiment, the values “0.055” and “1.055” may be experimentally derived and may vary as per experimental results and requirements. Further, in case the pixel value of the normalized RGB image is greater than the predefined threshold, the corresponding pixel is clustered in second cluster at step 318. Each of the pixel values of the pixels in the second cluster are scaled based on the second scaling factor. In an embodiment, the pixel values of the pixels in the second cluster may be divided by the second scaling factor. In an embodiment, the second scaling factor may be equal to, but not limited to, 12.92. Further, at step the output value of the first cluster at step 316 may be further raised to the power of 2.40 to generate a transformed normalized and added with the output of the second cluster at step 318 to generate an enhanced image.

The enhanced RGB image, at step 322, may be amplified or scaled based on a third scaling factor. In an embodiment, the third scaling factor is equal to, but not limited to 12.92 which may as a result generate a pixel modified RGB image at step 322. Further, at step 324, the pixel modified RGB image may be gamma corrected using a gamma correction technique to generate a color enhanced image frame and a final pre-processed image frame. In an exemplary embodiment, FIG. 4 depicts the pixel modified RGB image 418 and the generated color enhanced image frame and a final pre-processed image frame 420.

Referring now to FIG. 5, a Single Shot Detection (SSD) model 500 for detecting and classifying an object in real-time medical imaging is disclosed, in accordance with an embodiment of the current disclosure. FIG. 5 is explained in conjunction with FIGS. 1-4. The SSD model 500 may be an object detection model which may implement Deep Learning (DL) techniques to detect the objects in the imaging data. In some embodiments, the SSD model 500 may detect the object in a single pass over the input imaging data. Further, the SSD model 500 may predict at different scales from the feature maps of different scales and explicitly separates predictions by aspect ratio.

In some embodiments, the SSD model 500 may include the backbone model 504 and the SSD head 506. The backbone model 504 may be a pre-trained image classification network which may work as the feature map extractor. The final image classification layers of the model may be removed to give us only the extracted feature maps. The SSD head 506 may include the plurality of convolutional layers stacked together and added to the top of the backbone model 504 which may detect the various objects in the image 502. The SSD head 506 may generate an output as the bounding boxes over the detected objects.

In an embodiment, the SSD model 500 is based on convolutional network which may produce multiple bounding boxes of various fixed sizes and scores the presence of the object class instance in those boxes, followed by a non-maximum suppression step to produce the final detections. In some embodiments, the SSD model 500 may include the VGG-16 network as the backbone model 504.

In some embodiments, the SSD model 500 may receive the pre-processed image 420 as input which may be divided into grids of various sizes and at each grid, the detection is performed for different classes and different aspect ratios. Further, a score may be assigned to each of these grids based on how well an object matches in that particular grid. Further, the SSD model 500 may apply a non-maximum suppression to get the final detection from the set of overlapping detection. It should be noted that the SSD model 500 may use a plurality of grid sizes to detect the objects of plurality of sizes.

In some embodiments, the addition of every convolutional layers to the SSD model 500 may produce a fixed number of predictions of the detection of the plurality of objects using the convolutional filters present in each of the convolutional layer. Further, the convolutional layers added on top of the backbone model are responsible for detecting objects at a plurality of scales and may be composed of convolutional and pooling layers.

By way of an example, the SSD model 500 may divide an image using a grid and each grid cell may detect object in the region of the image. In an embodiment, the detection of objects means predicting the class and location of an object within that region. If no object is present, the SSD model 500 may consider it as the background class and may ignore the location.

In an embodiment, for detection of the plurality of objects in the grid cell or to detect the objects of plurality of shapes, the SSD model 500 may deploy anchor boxes and receptive fields. In some embodiments, each grid cell in the SSD model 500 may correspond with the plurality of anchor boxes. The anchor boxes may be pre-defined and each of the anchor boxes may be responsible for a size and shape within the grid cell.

In some embodiments, the receptive field may be the size of the region in the image that may produce the features. In simpler words, the receptive field may be a measure of association of an output feature to the input image region. Further, the receptive region may be defined as the region in the input space that a particular CNN's feature is looking at (i.e., be affected by).

In some embodiments, the SSD model 500 may allow pre-defined aspect ratios of the anchor boxes to implement the SSD model 500 on objects of the plurality of sizes. Further, a ratios parameter may be used to specify the plurality of aspect ratios of the anchor boxes associated with each grid cell at each zoom/scale level. It should be noted that the anchor box may be as same as the size as the grid cell, smaller than the grid cell, or larger than the grid cell. Further, a zoom parameter may be used to specify how much the anchor boxes need to be scaled up or down with respect to each grid cell.

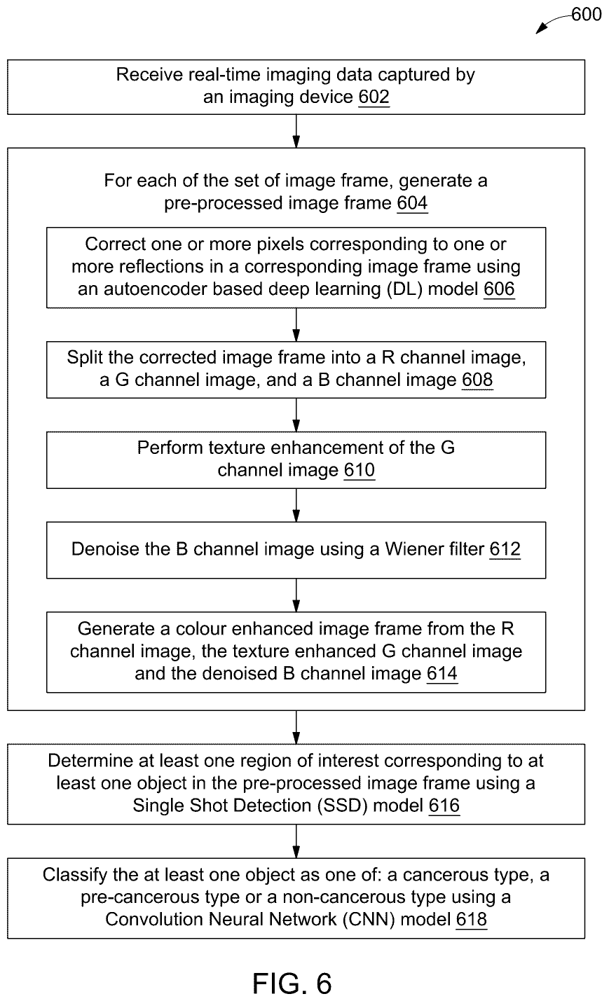

Referring now to FIG. 6, a method for detecting and classifying an object in real-time medical imaging is disclosed via a flowchart 600, in accordance with an embodiment of the current disclosure. FIG. 6 is explained in conjunction with FIGS. 1-5. Each step of the flowchart 600 may be executed by various modules (same as the modules of the system 200).

At step 602, the image processing device 102 may receive the real-time imaging data captured by an imaging device 112. The imaging data may include a set of image frames 502.

Further, for each of the set of image frames 502, at step 604, the image processing device 102 may generate a pre-processed image frame. In some embodiments, the generation of pre-processed image frame may be generated based on a plurality of steps 606-614. At step 606, the image processing device 102 may correct one or more pixels corresponding to one or more reflections in a corresponding image frame 502 using an autoencoder based deep learning (DL) model. It should be noted that the autoencoder based DL model is trained to correct one or more pixels corresponding to the one or more reflections based on the corresponding input image frame 502.

Further, at step t step 608, the image processing device 102 may split the corrected image frame into an R channel image, a G channel image, and a B channel image.

At step 610, the image processing device 102 may perform a texture enhancement of the G channel image generated at step 608. Further, at step 612, the image processing device 102 may denoise the B channel image using a wiener filter generated at step 608.

Further, at step 614, the image processing device 102 may generate a color enhanced image frame from the R channel image, the texture enhanced G channel image and the denoised B channel image. The generation of color enhanced image frame may include normalization of the R channel image, the texture enhanced G channel image, and the denoised B channel image based on a predefined normalization threshold range. Further, upon normalization of the R channel image, the texture enhanced G channel image, and the denoised B channel image, the image processing device 102 may determine a modified RGB image frame based on a predefined modification factor and performing a gamma correction based on a second predefined gamma correction parameter.

In some embodiments, the determination of the modified RGB image frame may include the image processing device 102 to generate a normalized RGB image by combining the normalized R channel image, the texture enhanced G channel image, and the denoised B channel image. Further, the image processing device 102 may segregate each of a plurality of pixels of the normalized RGB image into one of a first cluster or a second cluster based on a pre-defined clustering threshold. The image processing device 102 may generate an enhanced image frame by scaling each of the plurality of pixels of the first cluster and the second cluster based on a first scaling factor and a second first scaling factor respectively to determine the modified RGB image frame.

At step 616, the image processing device 102 may determine at least one region of interest corresponding to at least one object in the pre-processed image frame using a Single Shot Detection (SSD) model 500. The SSD model 500 may be pre-trained to detect the at least one object by extracting one or more features from the pre-processed image frame corresponding to the at least one object. In some embodiments, the SSD model 500 may include a backbone model 504 and an SSD head 506. The backbone model 504 may be the pre-trained image detection network configured to extract the one or more features of the input image frames 502. The SSD head 506 may include a plurality of convolutional layers which may be stacked on top of the backbone model 504.

At step 618, the image processing device 102 may classify the at least one object as one of: a cancerous type, a pre-cancerous type or a non-cancerous type using a Convolution Neural Network (CNN) model. The CNN model may be pre-trained to determine a class of the at least one object from one of the cancerous type, the pre-cancerous type or the non-cancerous type based on determination of one or more object classification features.

In some embodiments, upon determination and classification of the objects in the input image frames, the image processing device 102 may display the real-time imaging data on a display screen with a bounding box corresponding to the at least one object in each of the corresponding pre-processed image frames. Further, the image processing device 102 may generate a report along with the bounding box. The report may include the classification of the at least one object and one or more recommendations determined based on the classification of the at least one object.

Thus, the disclosed method and system may overcome the technical problem of slow pre-processing of the images to detect and classify the objects in the images. The method and system provide means to detect and classify the polyps in real-time medical imaging. Further, the method and system may cater to accurate detection of the abnormal tissues using the imaging from the invasive medical devices. Further, the method and system provide a means to detect the abnormalities in the patient using the medical imaging methods such as colonoscopy, endoscopy, etc. Further, the method and system may deploy the autoencoder neural network model to cater to the faster processing of the images which may be done in real-time. The method and system may be deployed in the medical imaging techniques such as colonoscopy and endoscopy to efficiently diagnose and classify the polyps in the natural body cavities. Further, the method and system may be deployed for the surveillance and security purposes by detecting and classifying the objects and humans from the CCTV footage. The method and system may also generate reports which may include the diagnosis of the detected polyps and the classification of the corresponding polyps. Further, the method and system may also generate recommendations corresponding to the detected and classified polyps and other abnormalities in the patient's body.

In light of the above mentioned advantages and the technical advancements provided by the disclosed method and system, the claimed steps as discussed above are not routine, conventional, or well understood in the art, as the claimed steps enable the following solutions to the existing problems in conventional technologies. Further, the claimed steps clearly bring an improvement in the functioning of the device itself as the claimed steps provide a technical solution to a technical problem.

It is intended that the disclosure and examples be considered as exemplary only, with a true scope of disclosed embodiments being indicated by the following claims.

What is claimed is:

1. A method of detecting and classifying an object in real-time medical imaging, the method comprising:
receiving, by an image processing device, real-time imaging data captured by an imaging device,
wherein the imaging data comprises a set of image frames;
for each of the set of image frames:
generating, by the image processing device, a pre-processed image frame by:
correcting, by the image processing device, one or more pixels corresponding to one or more reflections in a corresponding image frame using an autoencoder based deep learning (DL) model;
splitting, by the image processing device, the corrected image frame into a R channel image, a G channel image, and a B channel image;
performing, by the image processing device, texture enhancement of the G channel image;
denoising, by the image processing device, the B channel image using a Wiener filter; and
generating, by the image processing device, a color enhanced image frame from the R channel image, the texture enhanced G channel image and the denoised B channel image;
determining, by the image processing device, at least one region of interest corresponding to at least one object in the pre-processed image frame using a Single Shot Detection (SSD) model,
wherein the SSD model is pre-trained to detect the at least one object by extracting one or more features from the pre-processed image frame corresponding to the at least one object; and
classifying, by the image processing device, the at least one object as one of: a cancerous type, a pre-cancerous type or a non-cancerous type using a Convolution Neural Network (CNN) model.

2. The method of claim 1, wherein the generation of the pre-processed image frame comprises:
enhancing, by the image processing device, a contrast level of the corresponding image frame using a gamma correction technique based on a first predefined gamma correction parameter.

3. The method of claim 1, wherein the autoencoder based DL model is trained to correct one or more pixels corresponding to the one or more reflections based on the corresponding input image frame.

4. The method of claim 1, wherein the generation of the color enhanced image frame comprises:
normalizing, by the image processing device, the R channel image, the texture enhanced G channel image, and the denoised B channel image based on a predefined normalization threshold range; and
determining, by the image processing device, a modified RGB image frame based on a predefined modification factor and performing a gamma correction based on a second predefined gamma correction parameter.

5. The method of claim 4, wherein the determination of the modified RGB image frame comprises:
generating, by the image processing device, a normalized RGB image by combining the normalized R channel image, the texture enhanced G channel image, and the denoised B channel image;
segregating, by the image processing device, each of a plurality of pixels of the normalized RGB image into one of a first cluster or a second cluster based on a pre-defined clustering threshold; and
generating, by the image processing device, an enhanced image frame by scaling each of the plurality of pixels of the first cluster and the second cluster based on a first scaling factor and a second first scaling factor respectively.

6. The method of claim 1, wherein the SSD model comprises a backbone model and an SSD head, wherein the backbone model is a pre-trained image detection network configured to extract the one or more features, and
wherein the SSD head comprises a plurality of convolutional layers stacked on top of the backbone model.

7. The method of claim 1, comprising:
displaying, by the image processing device, the real-time imaging data on a display screen with a bounding box corresponding to the at least one object in each of the corresponding pre-processed image frames.

8. The method of claim 7, comprising:
generating and displaying, by the image processing device, a report along with the bounding box, wherein the report comprises the classification of the at least one object and one or more recommendations determined based on the classification of the at least one object.

9. The method of claim 1, wherein the CNN model is pretrained to determine a class of the at least one object from one of the cancerous type, the pre-cancerous type or the non-cancerous type based on determination of one or more object classification features.

10. A system for correcting a set of input images, comprising:
a processor; and
a memory communicably coupled to the processor, wherein the memory stores processor-executable instructions, which, on execution by the processor, cause the processor to:
receive real-time imaging data captured by an imaging device,
wherein the imaging data comprises a set of image frames;
for each of the set of image frames:
generate a pre-processed image frame based on:
correction of one or more pixels corresponding to one or more reflections in a corresponding image frame using an autoencoder based deep learning (DL) model;
splitting the corrected image frame into a R channel image, a G channel image, and a B channel image;
generation of a texture enhanced G channel image by performing texture enhancement of the G channel image;
generation of a denoised B channel image by denoising the B channel image using a Wiener filter; and
generation of a color enhanced image frame from the R channel image, the texture enhanced G channel image and the denoised B channel image;
determine at least one region of interest corresponding to at least one object in the pre-processed image frame using a Single Shot Detection (SSD) model,
wherein the SSD model is pre-trained to detect the at least one object by extracting one or more features from the pre-processed image frame corresponding to the at least one object; and
classify the at least one object as one of: a cancerous type, a pre-cancerous type or a non-cancerous type using a Convolution Neural Network (CNN) model.

11. The system of claim 10, wherein the generation of the pre-processed image frame is based on:
enhancement of a contrast level of the corresponding image frame using a gamma correction technique based on a first predefined gamma correction parameter.

12. The system of claim 10, wherein the autoencoder based DL model is trained to correct one or more pixels corresponding to the one or more reflections based on the corresponding input image frame.

13. The system of claim 10, wherein the generation of the color enhanced image frame is based on:
normalization of the R channel image, the texture enhanced G channel image, and the denoised B channel image based on a predefined normalization threshold range; and
determination of a modified RGB image frame based on a predefined modification factor and performing a gamma correction based on a second predefined gamma correction parameter.

14. The system of claim 13, wherein the determination of the modified RGB image frame is based on:
generation of a normalized RGB image by combining the normalized R channel image, the texture enhanced G channel image, and the denoised B channel image;
segregation of each of a plurality of pixels of the normalized RGB image into one of a first cluster or a second cluster based on a pre-defined clustering threshold; and
generation of an enhanced image frame by scaling each of the plurality of pixels of the first cluster and the second cluster based on a first scaling factor and a second first scaling factor respectively.

15. The system of claim 10, wherein the SSD model comprises a backbone model and an SSD head, wherein the backbone model is a pre-trained image detection network configured to extract the one or more features, and
wherein the SSD head comprises a plurality of convolutional layers stacked on top of the backbone model.

16. The system of claim 10, wherein the processor is configured to:
display the real-time imaging data on a display screen with a bounding box corresponding to the at least one object in each of the corresponding pre-processed image frames.

17. The system of claim 16, wherein the processor is configured to generate and display a report along with the bounding box, wherein the report comprises the classification of the at least one object and one or more recommendations determined based on the classification of the at least one object.

18. The system of claim 10, wherein the CNN model is pretrained to determine a class of the at least one object from one of the cancerous type, the pre-cancerous type or the non-cancerous type based on determination of one or more object classification features.

19. A non-transitory computer-readable medium storing computer-executable instructions for extracting relevant data from a document image, the computer-executable instructions configured for:
receiving real-time imaging data captured by an imaging device,
wherein the imaging data comprises a set of image frames;
for each of the set of image frames:
generating a pre-processed image frame by:
correcting one or more pixels corresponding to one or more reflections in a corresponding image frame using an autoencoder based deep learning (DL) model;
splitting the corrected image frame into a R channel image, a G channel image, and a B channel image;
performing texture enhancement of the G channel image;
denoising the B channel image using a Wiener filter; and
generating a color enhanced image frame from the R channel image, the texture enhanced G channel image and the denoised B channel image;
determining at least one region of interest corresponding to at least one object in the pre-processed image frame using a Single Shot Detection (SSD) model,
wherein the SSD model is pre-trained to detect the at least one object by extracting one or more features from the pre-processed image frame corresponding to the at least one object; and
classifying the at least one object as one of: a cancerous type, a pre-cancerous type or a non-cancerous type, using a Convolution Neural Network (CNN) model.

20. The non-transitory computer-readable medium of claim 19, wherein the generation of the pre-processed image frame comprises:
enhancing a contrast level of the corresponding image frame using a gamma correction technique based on a first predefined gamma correction parameter.
